(19) United States
(12) Patent Application Publication
(10) Pub. No.: US 2011/0288942 A1
(43) Pub. Date: Nov. 24, 2011

(54) METHOD OF PRODUCING A PRINTED PRODUCT

(75) Inventors: Jacobus Johannes De Wet, Cape Town (ZA); Sheraan Amod, Cape Town (ZA)

(73) Assignee: Mine Bang Media (Pty) Ltd, Cape Town (ZA)

(21) Appl. No.: 13/125,146

(22) PCT Filed: Aug. 27, 2009
(86) PCT No.: PCT/IB2009/053748

§ 371 Date: Jun. 21, 2011

(30) Foreign Application Priority Data
Oct. 30, 2008 (ZA) 2008/09299

(51) Int. Cl. G06Q 30/00; G06K 15/02

(52) U.S. Cl. 705/14.73; 705/14.4; 358/1.18

(57) ABSTRACT

The invention discloses a method of producing a printed product, which includes the steps of retrieving user data from an online social network platform and/or client database and/or user database; of compiling a printed product incorporating and/or based on the user data and/or preferences, interests, shared interests, online profile, and/or profile of the user and/or the user's friends and/or editorial content from publishers which are matched to users based on the user and/or the user's friends, preferences and/or profiles; and of printing and/or producing/manufacturing the printed product. The method furthermore includes the step of delivering the product to the user and/or to a location where the user can collect the product.

### FIELD OF INVENTION

The present invention relates to method of producing a printed product.

More particularly, the present invention relates to a method of producing a printed product utilising online social networking platforms and/or client databases and/or user databases and/or data stores in order to personalize a product and/or make it seem unique.

### BACKGROUND TO INVENTION

The Internet and in particular the World Wide Web have developed and advanced to the point where people are integrating online tools and services into their lifestyles. Social networking (e.g. Facebook™) has become prolific, with millions of people sharing personal information about themselves and connecting to each other in new ways. People are using the Web to store and remind them of their calendar appointments, friends' birthdays and upcoming events as well as to receive recommendations for consumer products based on their interests or habits.

Simultaneously, online business models and practices have evolved and created new innovations such as freely available software services and highly targeted advertising. Internet companies such as Amazon.com™ have pioneered breakthroughs in international logistics, with people being able to order common physical products from the Internet and get them delivered directly to their own address. The recent advances in digital printing have created an entire on-demand publishing industry (e.g. Lulu.com™) that supports its customers entirely via the Internet. In terms of user behaviour, it is clear that increasing numbers of people are using Web platforms as utilities to add value to their lives—often on a daily basis. Highly targeted, one-on-one advertising has emerged as an effective way to monetize this online ecosystem.

The fundamental problem with augmenting one's life with content from the social web is that accessing the valuable benefits of it (e.g. friends' birthday reminders on social networking platforms) demands that one uses a computing device. Viewing your full contact list, events, photos with friends and birthday reminders, necessitate getting online (e.g. through a PC, laptop or mobile phone) and logging in to a social network of choice. This is hereinafter referred to as the “screen domain” or “online domain”. The extreme utility of social networks means that several people who do not usually spend massive amounts of time in the “screen domain” (e.g. teenage females) now do so only to enjoy the social value of it. At this same time of rapid consumer and business movement to the “screen domain” (i.e. increased usage of hi-tech products), many “low-tech” habits of people remain fixed, or slow to change at best. A prime example of this is the relationship that people have with physical paper or print media such as books, calendars, diaries, journals, maps and magazines (amongst others). Most people still use these “low tech” products, and continue to gain value from their utility despite the fact that online products may offer superior functionality. This is hereinafter referred to as the “offline domain”. Perhaps the reason for slow-changing human behaviour can be better understood by psychologists, but a simple trend is easily noticeable by any ordinary person: while most people (particularly the young) flock to online social networking platforms, many continue to use physical offline products in their daily lives—often manually writing down information that exists digitally in the “screen domain”.

Another problem is that a user buys or subscribes to a magazine but not all content thereof are relevant to customers in each publication. Certain feeds can be more accurate in this regard, yet the problem arises again of “being online” in order to have access to this information.

There is a famous aphorism that states, “The more things change, the more they stay the same”. A relevant example would be the heralding of the “paperless office” in the 1990s—largely due to the ubiquity of powerful computing—and yet current research shows that offices are drowning in more paper than ever before, despite having the most advanced technology yet! There is something about a physical, tangible, pick-it-up-and-touch-it product that people are still deeply in love with.

It is an object of the invention to suggest a method of producing a printed product, which will assist in overcoming these problems.

SUMMARY OF INVENTION

According to the invention, a method of producing a printed product includes the steps
(a) of retrieving user data from an online social network platform and/or client database and/or user database and/or direct data input from a user;
(b) of compiling a printed product incorporating and/or based on the user data and/or preferences, interests, shared interests, online profile, and/or profile of the user and/or the user's friends and/or editorial content from publishers which are matched to users based on the user and/or the user's friends preferences and/or profiles; and
(c) of printing and/or producing/manufacturing the printed product.

The invention also extends to a printed product obtained by the method as described herein.

Yet further according to the invention, a printed product includes a printed product which incorporates and/or is based on user data and/or preferences, interests, shared interests, online profile, and/or profile of the user and/or the user's friends and/or editorial content from publishers which are matched to users based on the user and/or the user's friends preferences and/or profiles from from an online social network platform and/or client database and/or user database and/or direct data input from a user.

Yet further according to the invention, a method of advertising includes the steps
(a) of retrieving user data from an online social network platform and/or client database and/or user database and/or direct data input from a user;
(b) of compiling a printed product incorporating advertisements based on the user data data and/or preferences, interests, shared interests, online profile, and/or profile of the user and/or the user's friends and/or editorial content from publishers which are matched to users based on the user and/or the user's friends preferences and/or profiles; and
(c) of printing and/or producing/manufacturing the printed product.

The method may include the step of delivering the product to the user and/or to a location where the user can collect the product.

Print and/or printing may include publishing of the product on an offline medium.

The method may include the step of incorporating the user data into a template of the printed product.

The printed product may include advertisements.

The printed product may include useful user information (such as birthdays).

The method may provide for the placement of advertisements in the online domain, but which are then published in the offline domain.

The method may be used for targeted advertising.

The method may incorporate intelligent dynamic pay-per-placement billing.

The method may incorporate Internet-driven business model innovations in an offline medium. In the specification hereinafter the term “offline” refers to a state where a user is not able to automatically refresh information in time, e.g. print.

The method may include software applications for online social networking platforms to extract data from user profiles or information filled into a form and/or from secondary sources matched to a user.

The user data may include user profiles and/or direct data inputs from user such as user photos uploads.

Demographically targeted advertisements may be placed onto the products.

Advertisements may be delivered via an associated online advertising platform website for marketers.

The method may operate in the web software, advanced marketing and/or published media spaces and/or print advertising.

The social network platforms may include any intelligent electronic platform with which users can interact and share information with each other.

The method may operate on various social networks and/or data stores simultaneously, enabling one advertiser access to users of multiple social networks. The user may obtain access to templates, designs, photos, editorials, advertisements from multiple sources.

Users may integrate other content with their social network information e.g. Flickr, RSS feeds, blogs, wikis.

Other content may be integrated with a user's social network information.

A cost may be estimated of how much advertisers may need to pay for advertising based on the profile of customers and the demand for and availability of desired space in the product and/or bidding for user specifics/ demographics like age, gender, location, keywords.

The profile of the customer may be determined by the information the user publishes about himself or herself and/or data that is received from him or her completing a form and/or user profiles, questionnaires, forms filled in by users in order to personalize the product.

The form may exist in an application on the social network or website, and may verify the published data as well as request critical data that is not present on the profile and/or be matched to secondary sources to include more useful info into the product.

The profile may include demographic and keyword data such as age, gender and interests and physical location (or past locations visited) and/or previous social network and system platform/interactions by user.

Advertisers may sign up online and bid accordingly towards enabling their campaign.

The method may include a payment system.

The payment system may include a bidding system and/or a flat calculated rate.

The billing system may be dynamic and costs may fluctuate depending on the number of adverts published and the level of user targeting.

An advertiser may specify preferences about the consumers they are interested in.

The most basic preferences may be gender, age and/or location on any/every social network or data store.

The information may be published by the user of a social network and/or may be entered into direct data input and/or be published by the friend of a user.

Age may be determined by the users birthday.

Gender may rely on the user's supplied profile information.

Geographic location may be determined by the delivery address of the product and/or geographic network specified by the user.

Keyword searches may provide advertisers the advantage of narrowing down the group to whom they would like to advertise.

Data value may be added manually by the user and/or automatically be generated by the system to the product by intelligently including useful user information for the user onto the product as well as advertisements and/or editorial content and/or articles and/or other content the user might find interesting or of value.

The method may include critical data value component for the consumer which is the “useful information”, namely information existing on the social networking platform that does not yet exist in any offline media such as friend birthdays, events, photos with best friends and/or information from other data sources.

The method may combine useful user data and advertisements onto a predetermined product layout along with an attractive graphically designed skin that the user selects and/or self-designs.

Published print product may include at least one of the products selected from the group consisting of a printed calendar, a diary, map, magazine or any other product with a printable surface.

The product may be printed and delivered to the customers delivery address and/or to an address/collection point specified by the user.

The user may download the product and print it independently.

The method may utilize the implementation of a developer Application Programming Interface (API).

The method may include an advertising platform implemented as an online website or web software application that supports advertiser campaigns, intelligent billing and criteria selection and/or articles.

The criteria selection may distinguish between user criteria being demographics and contextual criteria being the content or kind of content that is placed.

The advertising platform may support the provision of both picture and text adverts, which may be included on the offline, published product and/or which are placed based on user info, editorials placed and/or the kind of product selected.

Advertisements may be placed in the Online domain but published in the Offline domain.

Basic company server computers and/or virtual software server systems may be physically installed at the printing houses where publishing occurs.

The printing house server may carry all of the non-variable data (e.g. calendar skins) and software necessary to compile a product, while the variable data (e.g. social user information, ads) may be sent to it over the Internet.

Delivery of the printed media may be accomplished by using registered mail or some other direct parcel delivery service and/or the user can pick up the products from a central location e.g. students collect from campus library.

The method may include standardized product templates that may be suitable for print.

The method may include the following steps to compile the product:
(a) selection or loading of the correct standardized product template;
(b) adding of the correct design skin (reusable objects) to the template;
(c) placing the relevant social network platform data and/or editorial content and/or other content and/or user information from secondary sources and/or forms filled in onto the template;
(d) placing the relevant advertisements and/or relevant editorial content and/or articles onto the template; and
(e) compiling and saving the final digital file (e.g. PPML and/or PDF) in a high quality, easily printable format.

The price of an advertisement may increase proportionally according to the number of criteria that an advertiser selects as well as those that the system is able to successfully match against an individual user, in addition to other factors and/or quality and completeness of the users profile.

Advertisers may be billed dynamically as their ads are placed on individual products.

Advertisement pricing may be influenced by:
(a) Selected criteria (e.g. age, gender, interest keyword, location)
(b) Advertisement size (e.g. A4, A5, business card)
(c) Demand (a bidding feature is likely to be implemented)
(d) Campaign limits (e.g. time frames, maximum budget)
(e) Paper and printing quality
(f) Amount of variable data in advertisement (e.g. John buy this iPhone for Sue, it is almost her Birthday)
(g) Page layout (e.g. backpage, next to user picture).

The zip/postal code information may be used to add specific area selection options to the advertising platform, allowing advertisers to reach an extremely high level of targeting.

Editorial content may be placed based on user profile and/or selection by user e.g. user wants all VW Polo reviews.

The method may include a step of matching or of allowing the user to match any media that can be printed to his/her interests, in such a way that there is benefit in the user receiving the product which includes this media.

The method may be used for the following products in addition to calendars:
(a) Diaries/daily planners (published and delivered, enhanced with a personalized address book, friend birthdays and event information and funded through targeted advertising and/or 3rd party content);
(b) Maps (incorporating personal information such as the location of friends and creating another ad display format for local businesses and/or trip planner);
(c) Magazines (by partnering with publishing houses, it would be possible to maintain the editorial content of popular magazines but change the advertisements to be individually targeted—and then deliver the published product to the user incorporating user photos); and/or
(d) A custom publication created by the user including at least one from (a) to (c) above and from any available content (e.g. that the user can choose their photos, events, editorials they are interested in and select the advertisements they want as the addition of advertisements into the product makes it cheaper for the user.)

### BRIEF DESCRIPTION OF DRAWINGS

The invention will now be described by way of example with reference to the accompanying schematic drawings.

In the drawings there is shown in:

FIG. 1: System flow diagram according to the invention;

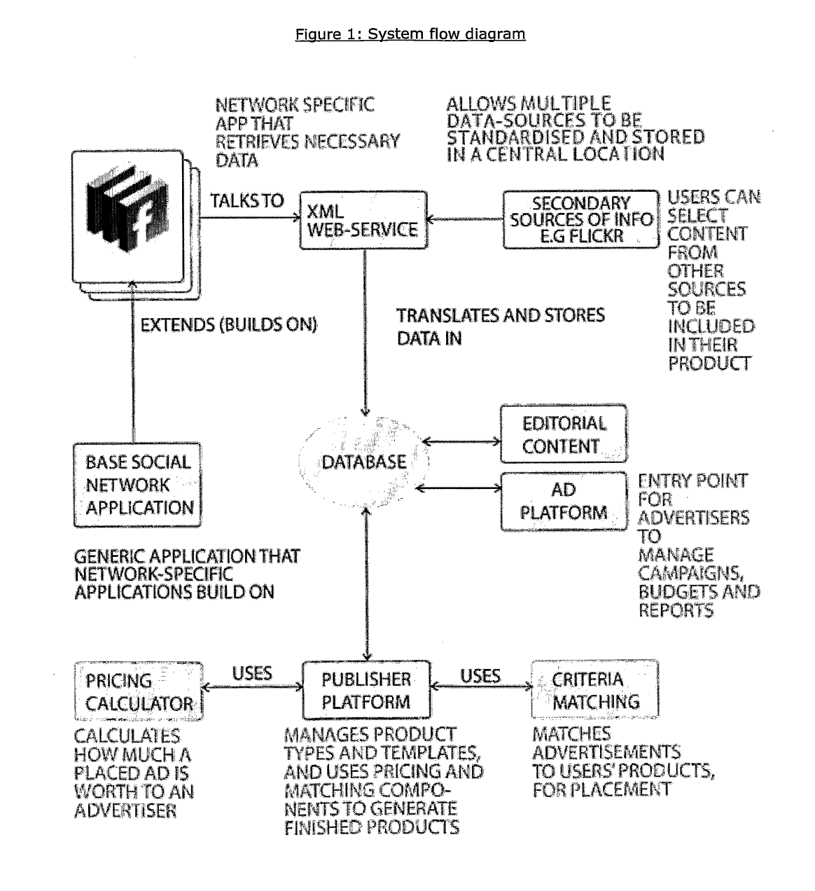

FIG. 2: Diagram of linking between the major technical platforms and business processes;

FIG. 3: Diagram of the highest level of the process;

FIG. 4: a: Highest level view of advertising platform function;

b: Advertising platform usage flow;

FIG. 5: End-to-end product creation and publication process;

FIG. 6: View of a month from the standardized calendar template;

FIG. 7: Full page magazine example;

FIG. 8: UML entity relationship diagram;

FIG. 9: Flow diagram;

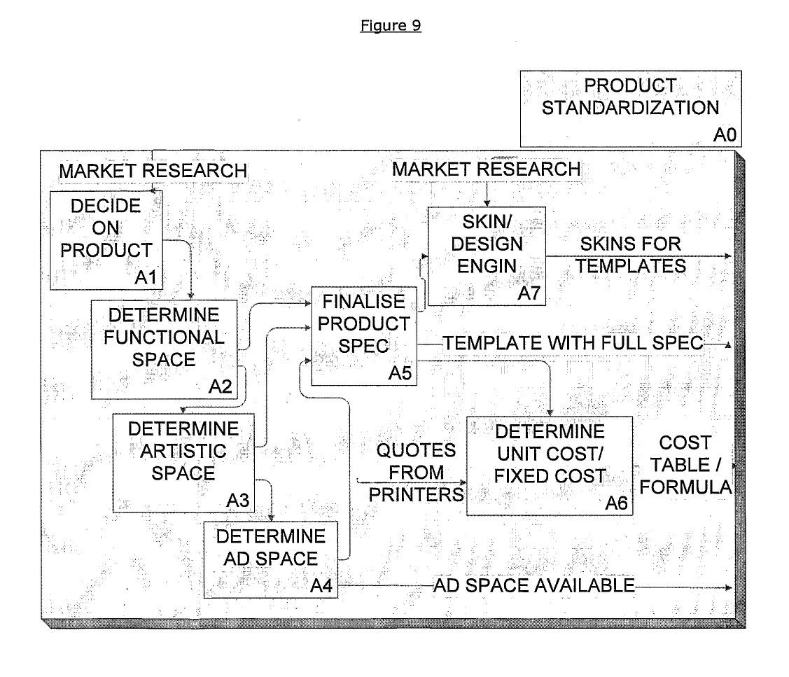

FIG. 10: Flow diagram;

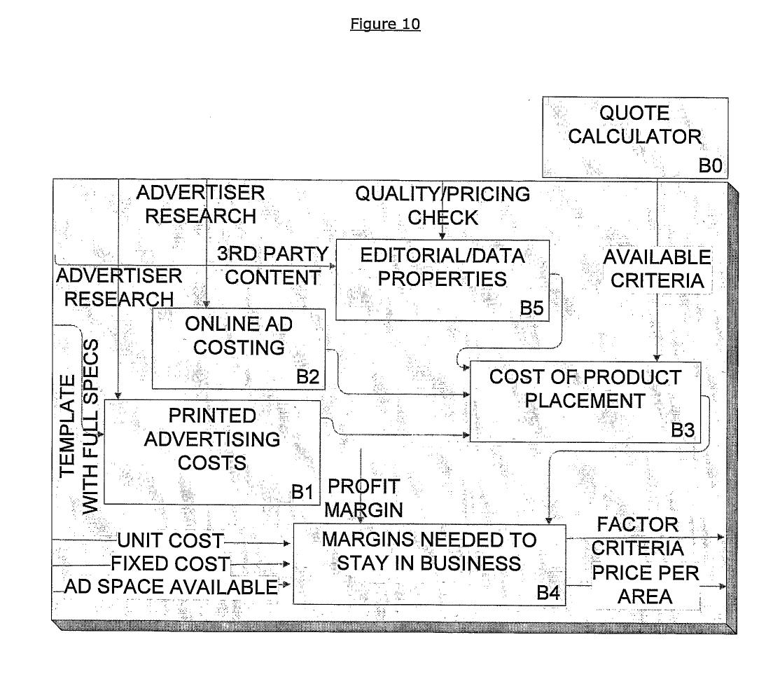

FIG. 11: Flow diagram;

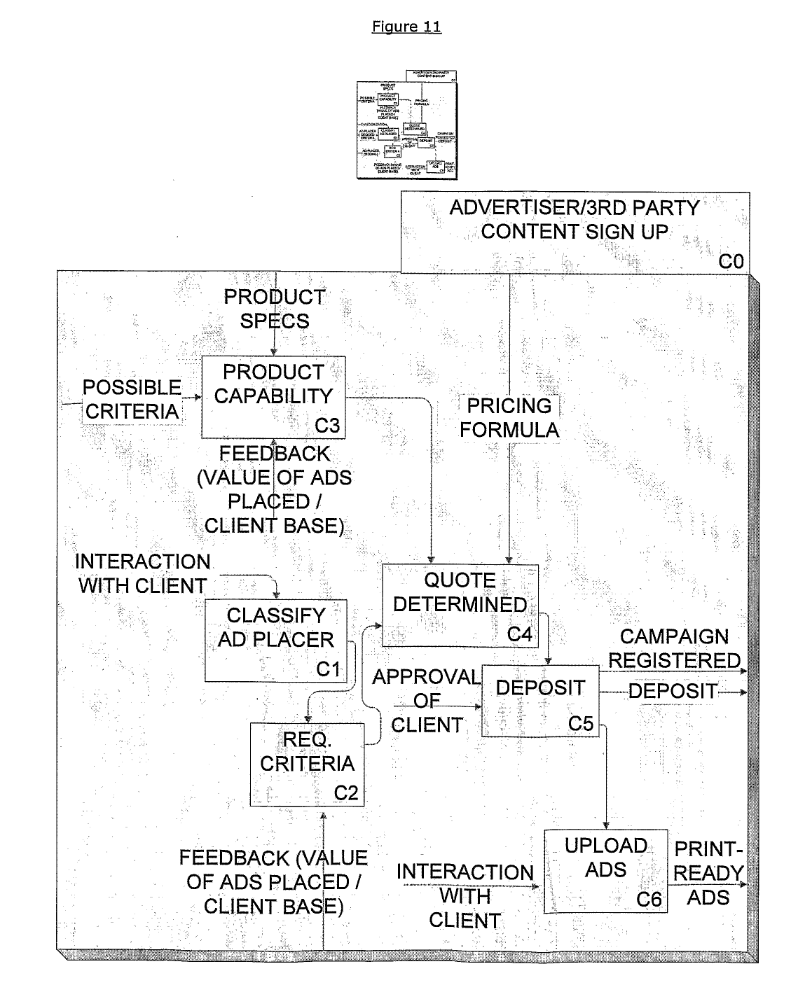

FIG. 12: Flow diagram;

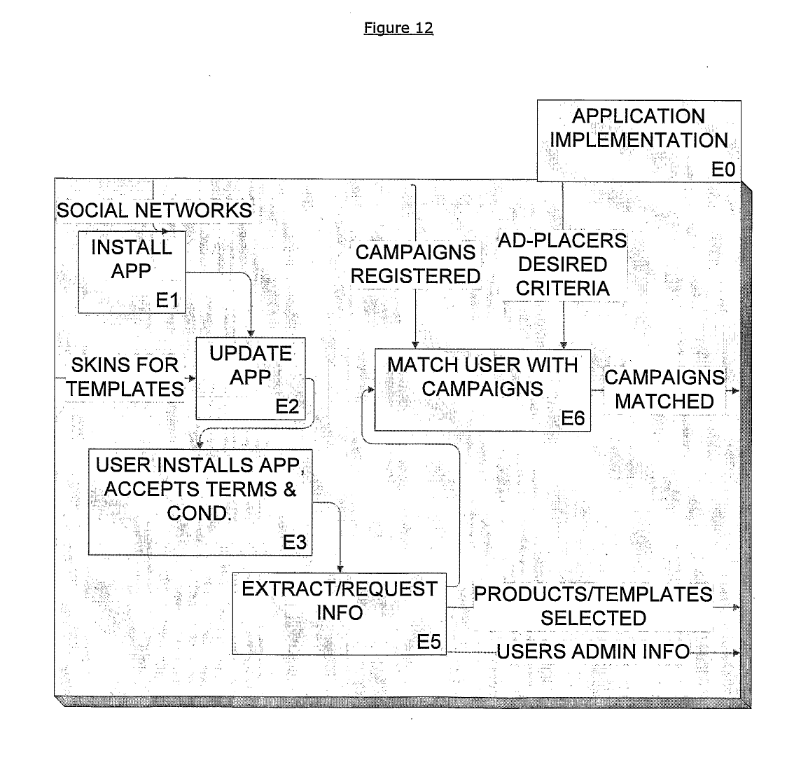

FIG. 13: Flow diagram;

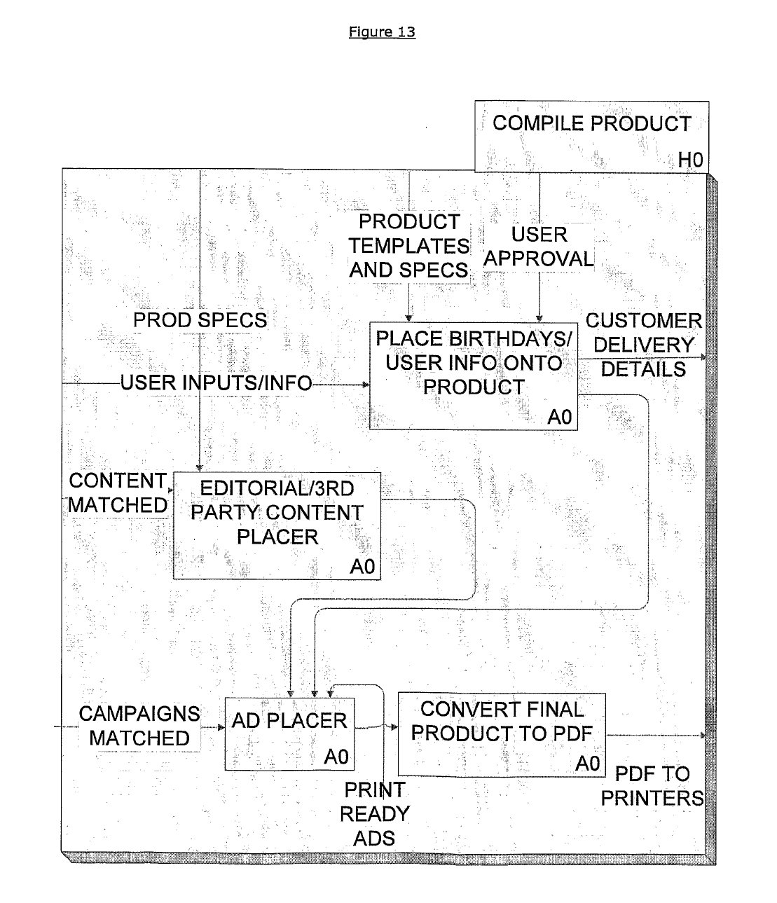

FIG. 14: Flow diagram;

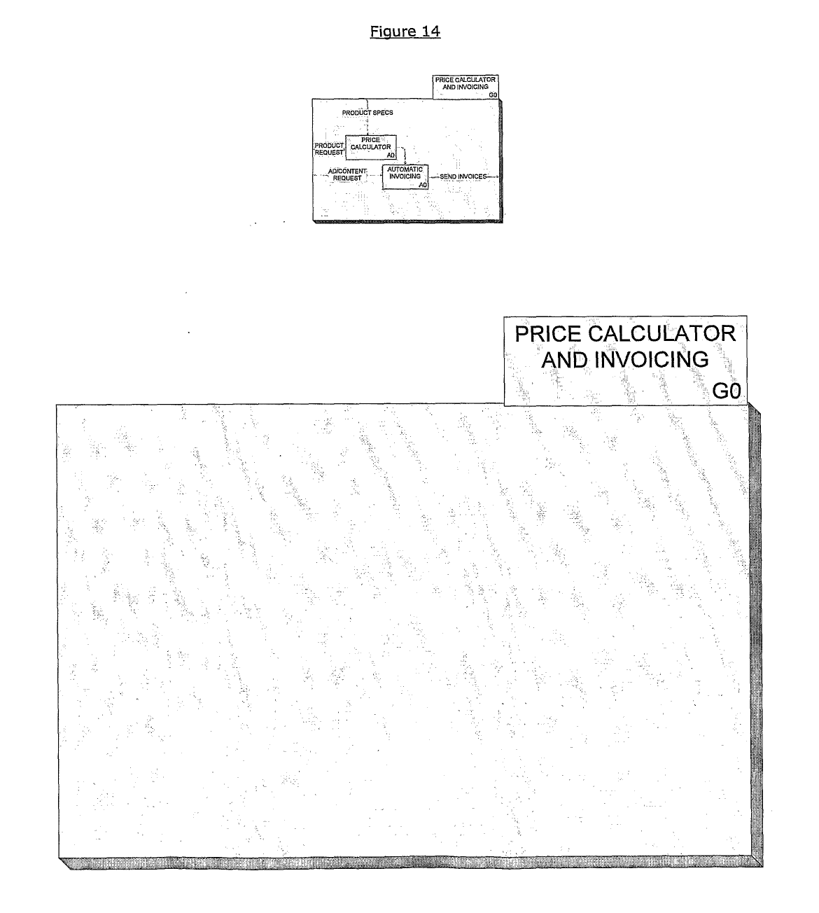

FIG. 15: Flow diagram;

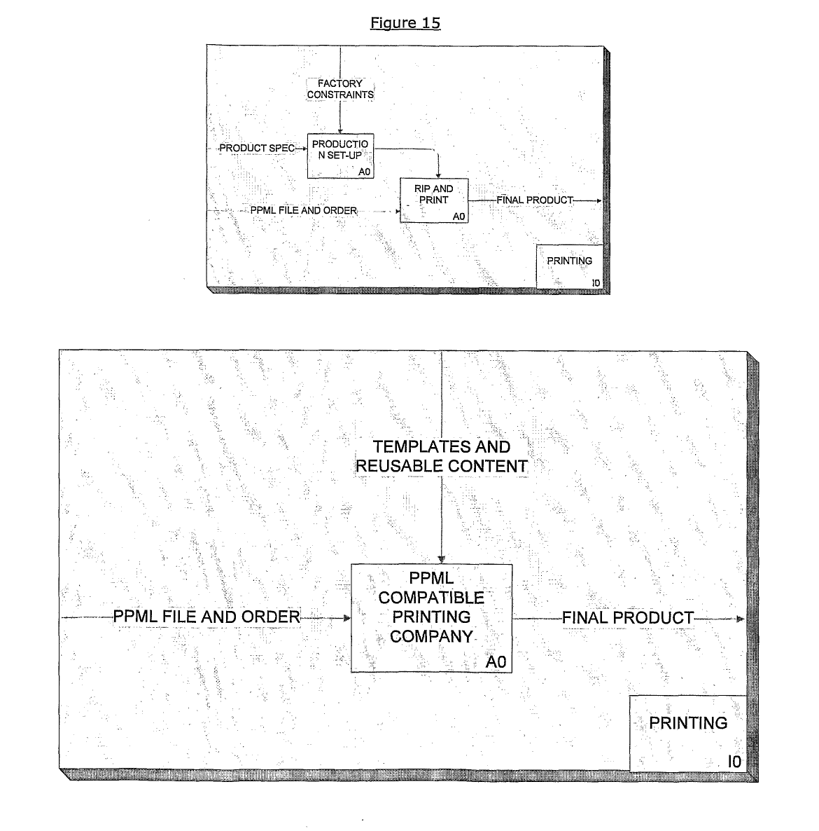

FIG. 16: Flow diagram;

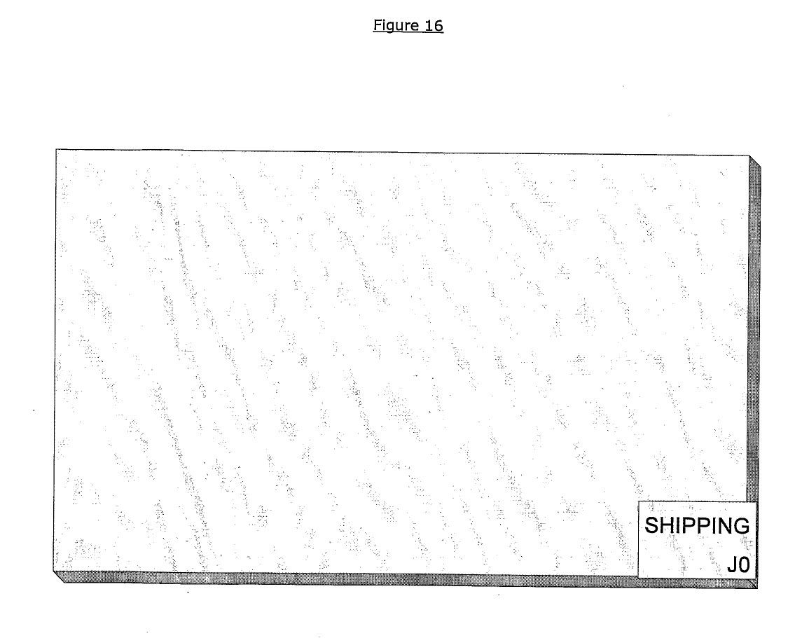

FIG. 17: Flow diagram;

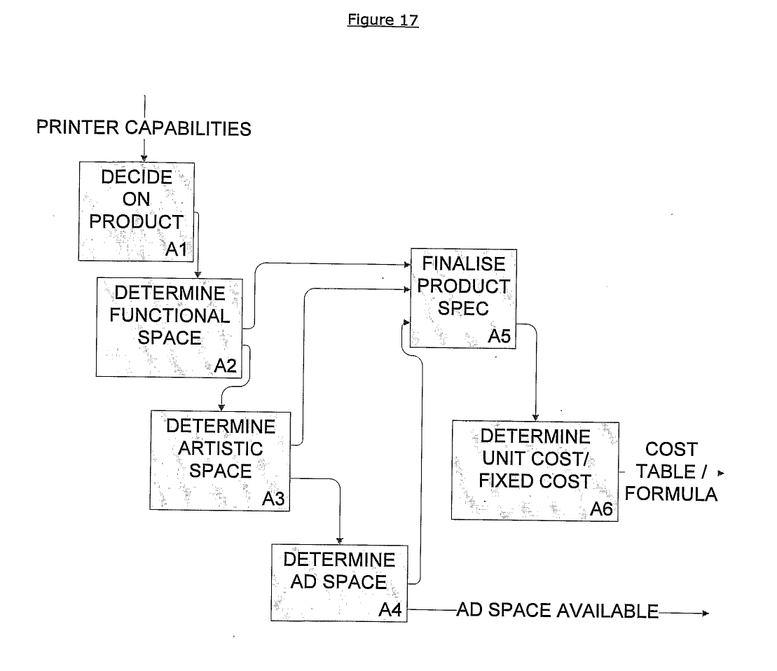

FIG. 18: Flow diagram;

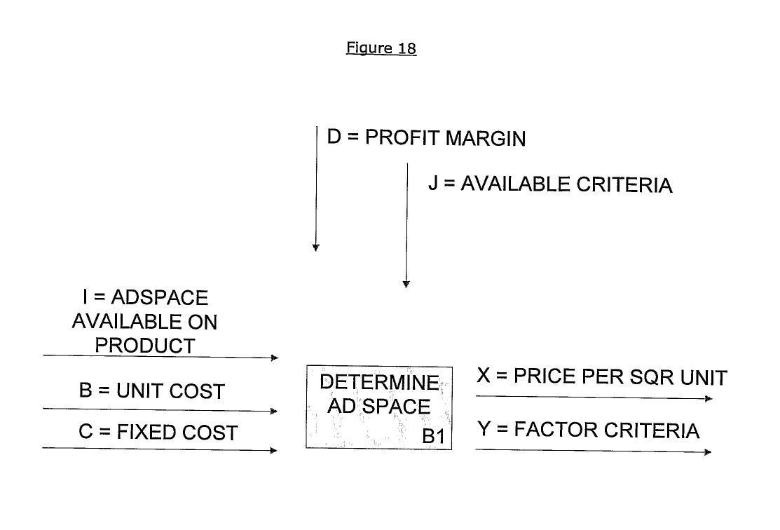

FIG. 19: Flow diagram;

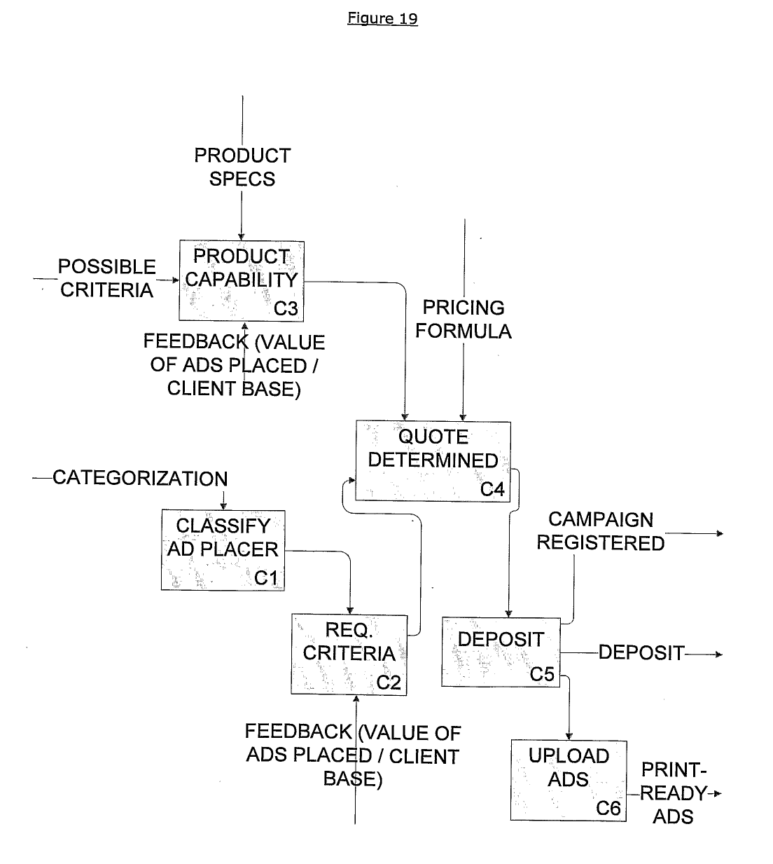

FIG. 20: Database entity relationship diagram;

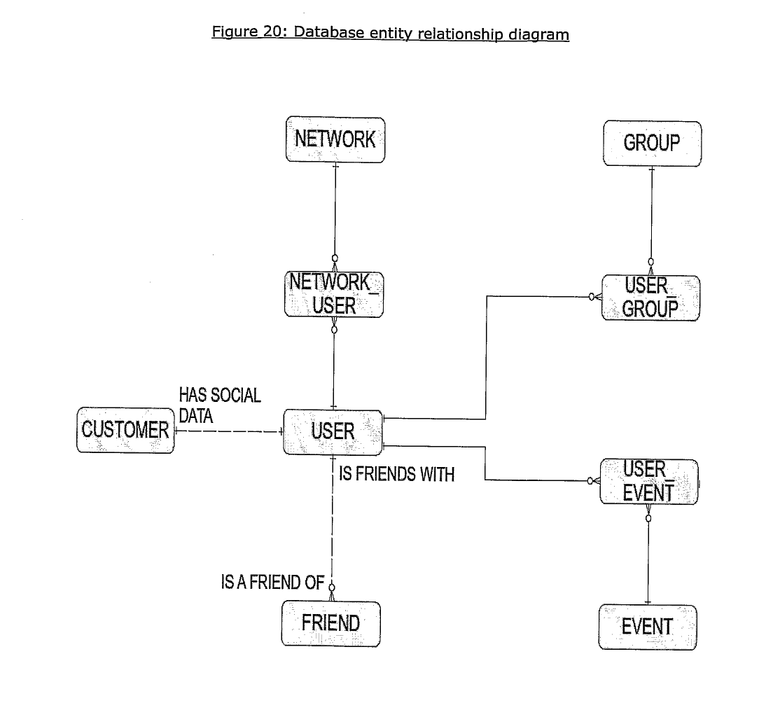

FIG. 21: Full page diary example; and

FIG. 22: Platform interaction diagram.

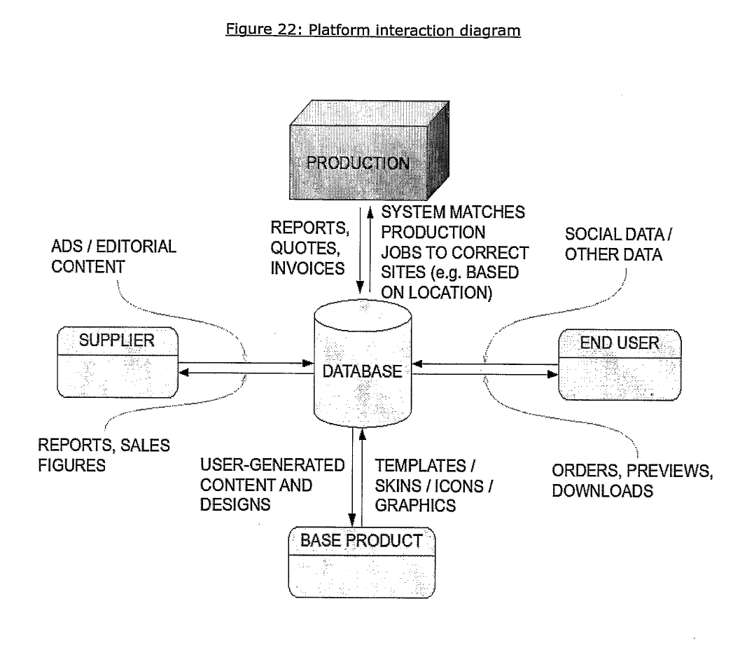

### DETAILED DESCRIPTION OF DRAWINGS

Referring to the drawings, an Internet system in accordance with the invention, is shown.

According to the invention, a method of producing a printed product includes the steps
(a) of retrieving user data from an online social network platform and/or client database and/or user database;
(b) of compiling a printed product incorporating and/or based on the user data; and
(c) of printing the printed product.

The method includes the step of incorporating the user data into a template of the printed product. The product is compiled from designs, templates, skins, ads, editorials, photos, events, maps, information.

The invention centers on the principle of moving seemingly exclusive value from the “online domain” into the “offline domain”. This applies to personal data value for individual consumers (providing offline access to information from the social web), as well as commercial value for businesses (enabling business options in the “offline domain” that were previously exclusive to the Web, or “online domain”).

Making personal data value available offline refers to moving information existing in online social networking platforms to published print products at marginal or zero cost to the user. Commercial value refers to the provision of targeted advertising, intelligent billing and other Internet-driven business model innovations in an offline medium: viz. published print products. In an age where startups focused on unleashing increasingly sophisticated services in the “screen or online domain” are gaining momentum, this approach is definitely contrarian.

The invention fulfils the requirements of certain fundamental human habits that have been largely overlooked in the flurry of activity, and carve an entirely new niche by augmenting people's offline lives (and business's offline options) with valuable published media of unmatched utility. Thereby the online value is evolved by business intelligence and innovation from online and offline domains into offline value.

The invention relates to the development of software applications for online social networking platforms that deal with user data extracted from user profiles and submitted directly users. This data is used to create value added offline, published media products that application users can order or benefit from. Demographically targeted advertisements are placed onto the products, and these ads are delivered via an associated online advertising platform website for marketers. This invention thus operates in the web software, advanced marketing, printed product and published media spaces.

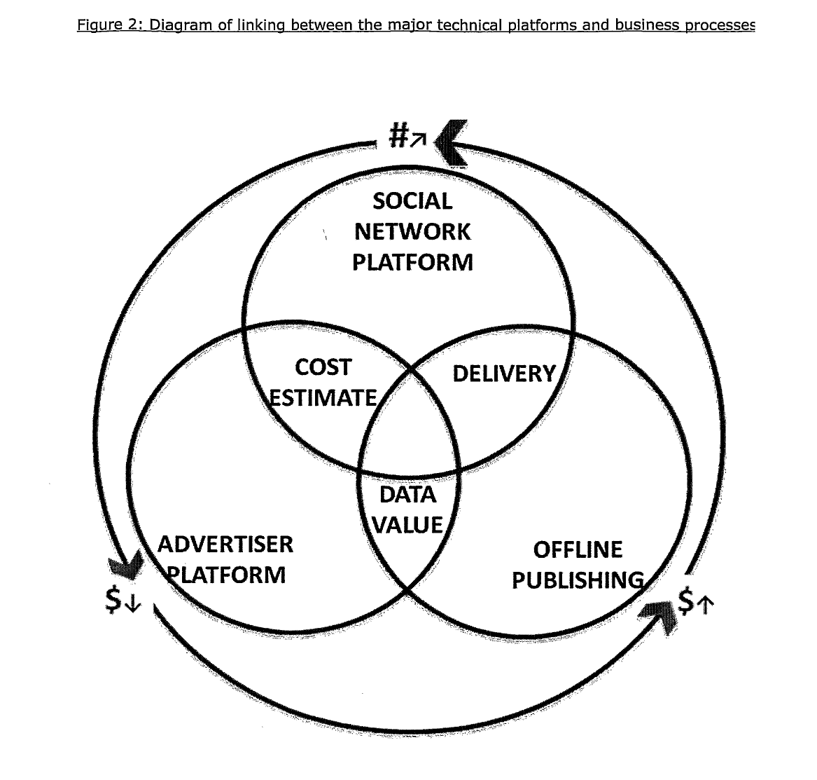

The primary invention is the unique method by which the major technical platforms and business processes are linked. This is expressed by the model as shown in FIG. 2.

Social network platforms represent any intelligent electronic platform with which users can interact with each other that is traditionally in the Screen domain. Typical examples include popular social networking websites such as Facebook™, Bebo™, LinkedIn™ and MySpace™.

A cost is estimated of how much advertisers would need to pay for advertising based on the profile of customers and the availability of desired space in the product (e.g. an A5-size advertisement in a printed user calendar). The profile of the customer is determined by the information the user publishes about himself or herself (demographic and keyword data such as age, gender and interests e.g. Beverly Hills USA=90210, New South Wales Australia=2010, Cape Town South Africa=8000), as well as the data that is received from him or her completing a form. The user clicks on “agree to terms & conditions” and then permission is given to use the information on the social network or data store. This form may exist in an application on the social network, and it would verify the published data as well as request critical data that is not present on the profile (e.g. user's delivery address). Information can also be matched with secondary data sources in order to have more information. This information can enhance the product or increase the ad spent and/or cost of ads.

Advertisers sign up online and bid accordingly towards initiating a campaign. The billing system would be dynamic and based on a combination of minimum pricing and/or bidding, determined by factors including (but not limited to) advert size and targeting criteria. An advertiser can specify preferences about the consumers they are interested in and elements around their profiles e.g. wall posts per week, friends, photos tagged, single friends etc. The most basic preferences are gender, age and/or location on any/every social network or data store. Some advertisers might only be interested in Bebo users or LinkedIn users. This information would either already be published by the user of a social network and/or be published by friends of him or her, or can be entered into a form or obtained by some other means. Age would be determined by the users birthday, gender would rely on the user's supplied profile information, and geographic location would be determined with the delivery address of the product or geographic network (an additional option on a social networking platform) that the user belongs to. Keyword searches would give advertisers the advantage of narrowing down the group to whom they would like to advertise (as seen with Facebook™ advertisements). Advertisers can for instance request to only place advertisements to people with the keyword ‘wine’, and would pay more as their criteria becomes increasingly specific. The advertisements (which would form part of an ad campaign in the online advertising platform) would then be matched with appropriate users according to the preset criteria, and the ads would then appear in print on the user's offline, published media product. The advertiser would be invoiced/payment is due, this payment is based on ads placed and criteria met for each one.

Data value is added to the product by intelligently including useful user information for the user onto the product as well as advertisements and/or editorial content. Editorial content can include photos, stories, articles, puzzles, quotes etc. either created or obtained for free (non-copyright material), or in licensed from 3rd parties e.g. publishers and/or crowd sourcing. Anyone using the platforms described can creat content/artwork that can be included into the products. This can then be used as well in the products. The data value to the user would be useful information, good layout or presentation of this information, the aesthetics and design of the product, and advertisements that the user would be interested in. The critical data value component for the consumer is the “useful information”, which is information existing on the social networking platform that does not yet exist in any professional produced offline media (e.g. friend birthdays, events, photos with best friends etc, users name, photos, friends names, interests used in printed advertisements, e.g. Bob, imagine surfing with Tony and Jake, and having an ice cold Powerade waiting for you). A system would thus combine useful user data and advertisements onto a predetermined product layout along with an attractive graphically designed skin that the user selects.

Offline publishing is the display of information from a file (in this case a PPML file with embedded data and resource references) onto a published print product. It is currently a printed calendar, but could also refer to any published item like a diary, map, magazine or any other product with a printable surface. PPML is used so extra servers (over and above what printers currently use) may not be necessary.

Delivery is the process by which the user that ordered the product via a social network platform receives the published product. It should be noted that publishing and delivery in the case of printed media would be the printing of a product and the delivery of it to the customers delivery address or collected from a central location e.g. campus library. Another way of delivery will also be for the user to download the product and print it independently. This latter case might become a customer satisfaction option for users who cannot obtain delivery of a printed product due to geographic constraints or difficult to monetize advertising profiles.

Social network platforms would allow viral, exponential growth of the number of users who may order products, while the difference between the income from advertisers and expenses of publishing would determine the profit margin on a product. These “users” refer to the users using the online platforms described in the invention and does not refer to the people ordering the products or use social networks. Costs incurred from publishing can be in-licencing of content (from 3rd parties, crowd sourcing cost, content searching cost etc.), production, and delivery.

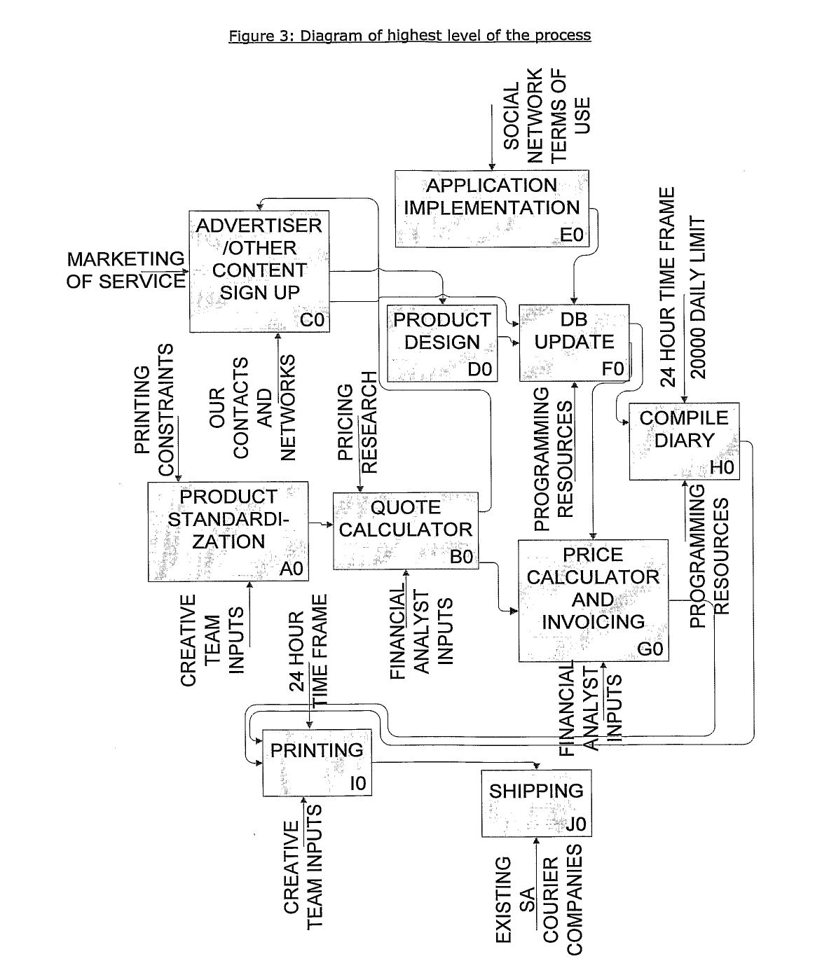

A highly detailed version of this functional process has been mapped out in the IDEF0 standard, and the highest level of the process is shown in FIG. 3.

Social Network Application

There are various social network platforms on the Web, but not all of them allow independent developers to write software applications that can be used on the platform. The social networks that allow this (e.g. Facebook™, MySpace™) do so by the implementation of a developer Application Programming Interface (API).

This is also commonly referred to as the “developer platform”. It allows independent developers to write software programs that can access user information and perform actions on a social network in the exactly the same manner as official or natively installed applications. It is through the creation and implementation of such an application that the company will attain users, access their information as well as receive and generate their product orders. This technique can be applied to all social network platforms that support developer APIs, thus allowing the company to develop a large pool of users across various different social networks, and make this entire user pool easily available to advertisers interested in targeting particular groups. The multiple applications across different social networks or web sites/data stores linking to the information on social networks would link to a single database where user and advertiser information are collected, stored, matched, ranked, and verified.

Online Advertising Platform

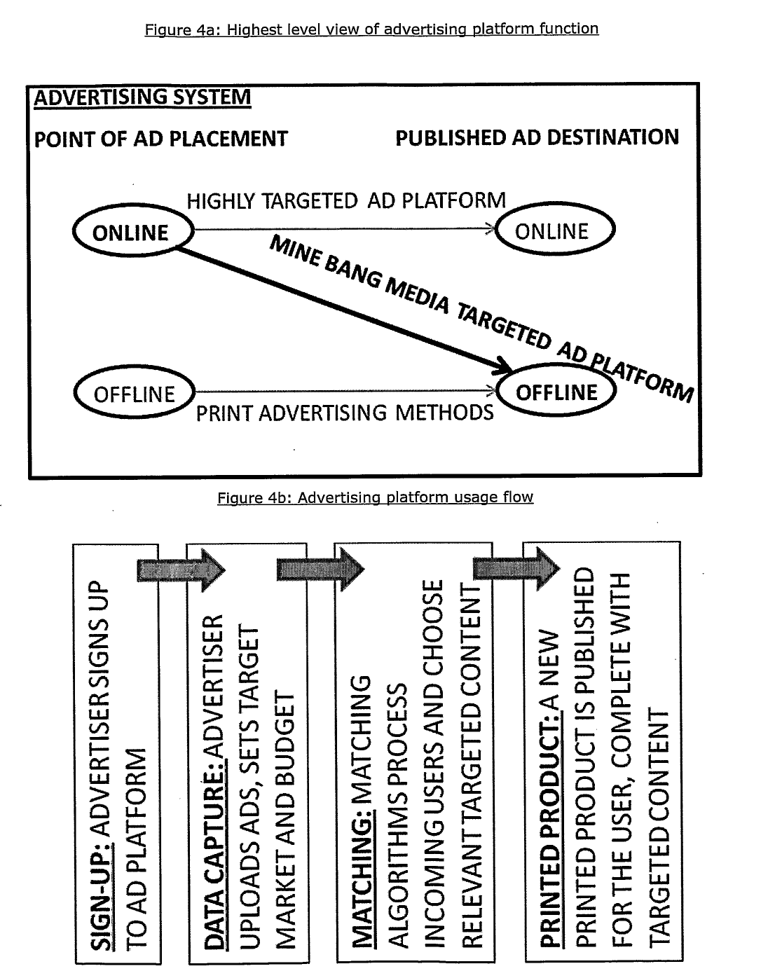

The advertising platform is implemented as an online website or web software application that supports advertiser campaigns, intelligent billing and criteria selection. It supports the provision of both picture and text adverts, which are then included on the offline, published product. The entire process is self-service, and automatically captured and delivered by the advertising platform software system (i.e. no human intervention from the company at any stage of the ad sale process). Although the manner of operation of the website is similar to other existing advertising platform sites (e.g. Lookery.com, Cubics.com, cadmium.avecora.com), its fundamental and unique difference is in its function: advertisements are placed from the Online domain but published in the Offline domain. The advertising platform invented here also allows for the most sophisticated targeting (demographic, location and keywords) ever available to advertisers in an offline, published, print media format. This basic distinction is shown in FIG. 4. The submission of editorial content for use in publications can happens in a similar fashion. Health publication can for example upload 100 workouts with pictures and tag words related to the exercises, so someone interested in rowing will receive all the upper body workouts if they order a health/fitness related product.

System Integration with Printing Houses

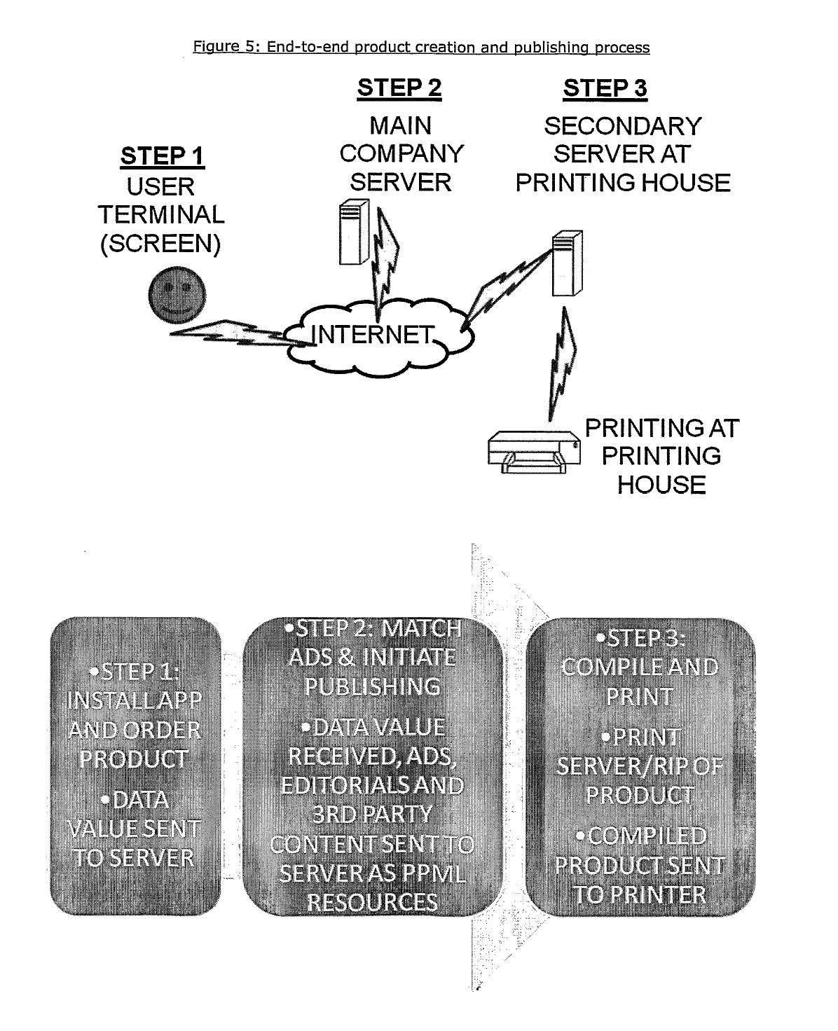

In order to reduce bandwidth costs and improve efficiency, basic company server computers may be physically installed at the printing houses where publishing occurs. The reason for this is to avoid sending the same large product templates and skins (e.g. a high quality calendar design) over the Internet to the printing house, as this would incur unnecessary bandwidth costs. Instead, the printing house server would carry all of the non-variable data (e.g. calendar skins) and software necessary to compile a product, while the variable data (e.g. social user information, ads) would be sent to it over the Internet. This basic method is shown in FIG. 5.

FIG. 5 does not show the advertising platform (it functions as a website hosted on the main company server) or delivery system (delivery is made from the printing house). There are unique objects (user info/photos) and reusable objects (skins, layouts, ads, editorials). Reusable objects are referred to as resources and would be sent to the printer once, while the unique objects are sent with every single product ordered /every time a batch of orders are sent through.

Delivery of Printed Media

Delivery of the printed media is accomplished by using mail or some other parcel delivery solution with the national postal service of the country where the user lives (i.e. their delivery address). For example, the South African Post Office's registered mail service could be used for orders delivered to South Africa. Registered mail allows users to track their orders, and postage would occur from the printing house after the product has been published (regional printing houses will be used). This system could fluctuate depending on the costs relating to shipping or airmail, but it is the likeliest solution at present.

Standardized Product Template

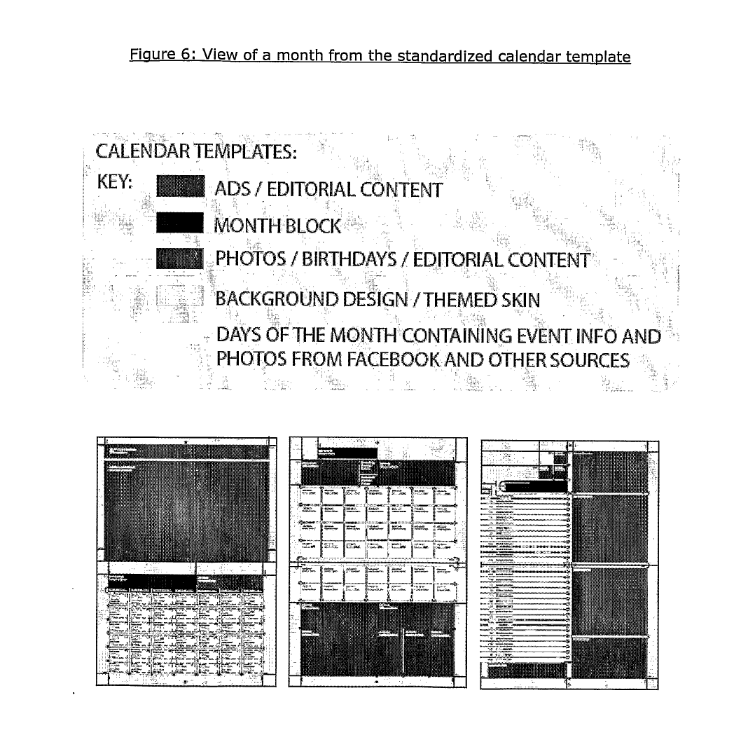

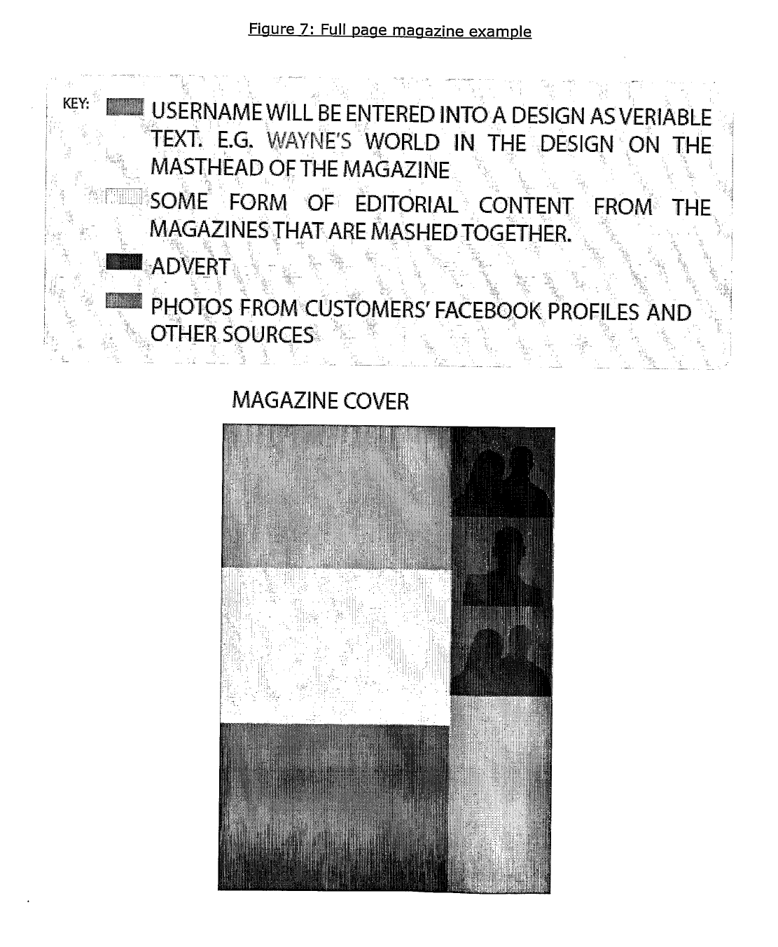

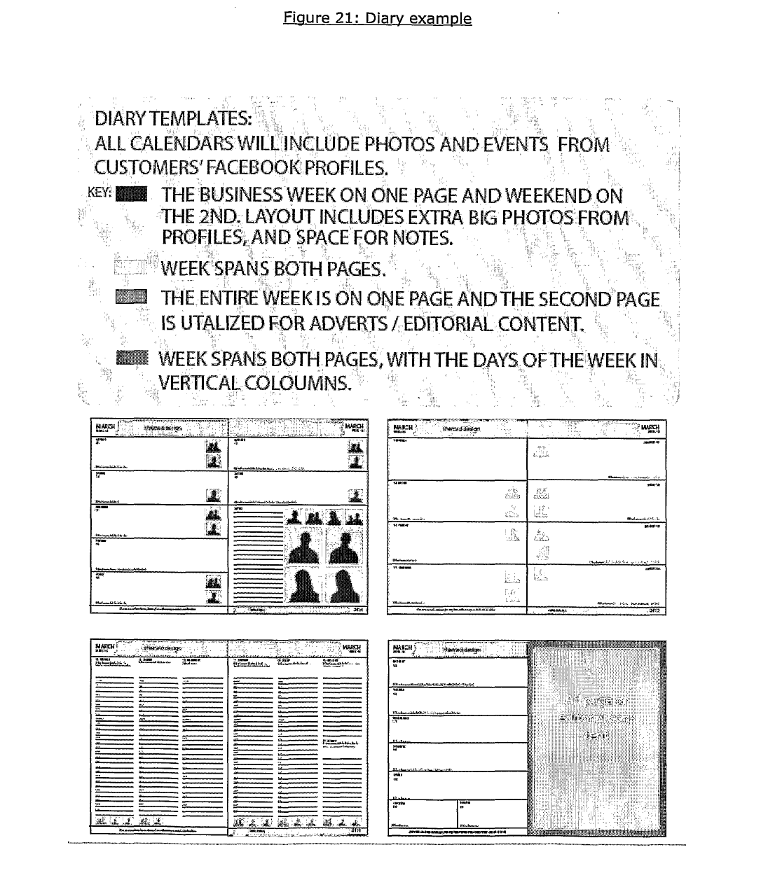

In order to reliably place relevant data value onto an ordered product automatically, a standardized product template was invented. This standardization process would occur for any new product, but the current template is specific to the company calendar. The standardized template shows the basic layout of critical blocks, such as the cover page, advertising spaces and information points. Using the calendar as an example, the standardized template would show the specific format of the cover pages, advertising layouts for each month and the day blocks for each month where friend birthday information is entered. The template includes editorial content blocks in the calendar example as well as user photos in some of the “advertisement blocks” as described herein. The boundaries of the template are recorded by the software compilation system, which is then able to intelligently place data into the correct places of the template (e.g. friend birthdays and graphical ads). An example of a month from the standardized calendar template is shown in FIG. 6, an example of a magazine template in FIG. 7 and a diary template in FIG. 21.

Automatic Digital Product Compilation Technique

In order to compile the final product (e.g. a calendar PDF) for publishing, various steps are sequentially performed to enable accuracy, resource efficiency and full system automation. A software program residing on the company server at the printing house may do the final compilation. The basic steps in compiling the product (after user ordering, ad matching and information collection) are:

1) Select or load the correct standardized product template

2) Add the correct design skin to the template

3) Place the relevant social network platform data and/or data from other sources relating to the user or user interests onto the template

4) Place the relevant advertisements, editorial content, variable ad info and other variable data (pictures and text) onto the template

5) Bind and save the final PDF in a high quality, easily printable format and save the final print-ready file

An example of a single calendar page with the data value and skin placed on top of the standardized template is shown in FIG. 7.

Print Ad Pricing Model

The method used to price advertisements is unique in the print advertising industry. The price of an advertisement increases according to the number of criteria that an advertiser selects as well as those that the system is able to successfully match against, in addition to other factors. Advertisers are billed dynamically as their ads are placed on individual products. The price for this kind of advertising has more value and can be priced higher, as only the right people see the right content (content appearing only applicable to them), and less paper is wasted as a result.

Advertisement pricing is influenced by:
Selected criteria (e.g. age, gender, interest keyword, location)
Advertisement size (e.g. A4, A5, business card): The advertisement size can be replace by all the factors influencing traditional advertising like size of advertisment, black and white or full colour, placement position in publication, kind of readership, kind of content etc.
Demand (a bidding feature is likely to be implemented)
Campaign limits (e.g. time frames, maximum budget, advert size)
The price can be higher if an advertisement is placed to a person targeted in an ad campaign and also to that persons friends in order to get social influence around the person originally targeted.

The price is settled for a single published advertisement, and advertiser costs are multiplied by the number of users who receive the ad in question. Due to the highly targeted nature of ads and large control of the advertiser over their campaign, this method is both more lucrative for the service provider and value adding for the ad buyer than current, traditional methods. The advertiser can choose to pay for targeting, but to get discount if there is no targeting e.g. BMW motors targets married university graduates and pays $1.50/ad but is still willing to pay $0.85/ad to people who are either married or graduates, but only pay $0.10/ad to people who are not married and not graduates.

An advertiser can launch a venue in a certain area by advertising a day in a product to a specific area and group of people e.g. all males between 25 and 35 living in the Sandton area are invited to a free Gym session at the Sandton Gym on the 1st of April 2011.

Zip/Postal Code Ad Platform Intelligence

This is another feature that might be implemented to varying degrees. In order to successfully deliver printed products, it is necessary to obtain a user's delivery address. The zip or postal code portion of the address is then used to do specific location targeting of the user, as they are specific down to individual areas (for example, South Africa has postal codes that can be grouped according to 5 major regions and further subdivided into 42 smaller regions). This concept holds true for most countries in the world.

The zip/postal code information is then used to add specific area selection options to the advertising platform, allowing advertisers to reach an extremely high level of targeting. The use of this feature allows advertisers to perform specific local ad targeting, in addition to the national or international options provided by the basic system. The focus of this part of the invention is valuable for geo-specific ad (or other content) targeting. This feature is also relevant to the map product.

Software Implementation

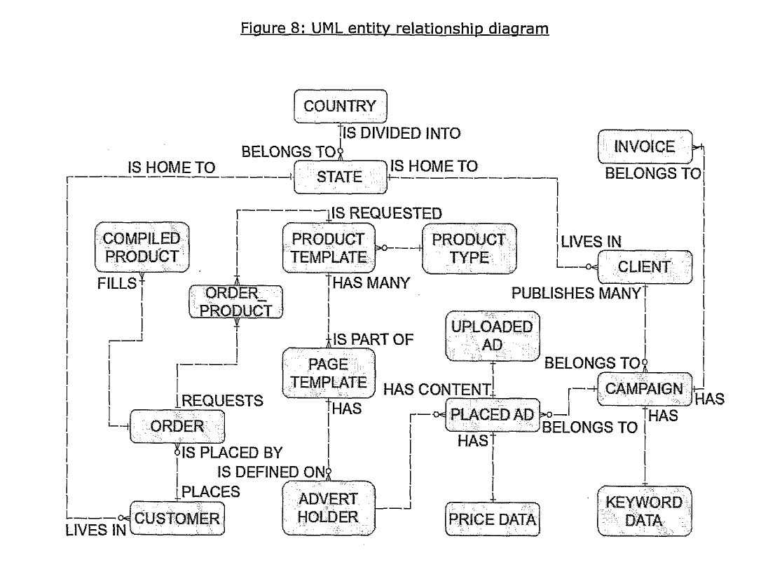

The invention is implemented in, or interacts with, a software system of unique design. The database system developed provides an innovative way to link the ad platform and social network application and other data stores or website linking to social network while also creating a company system storage space for operational data. This is shown in the UML entity relationship diagram of FIG. 8. This links with CRM and SRM systems where print product users are seen as customers and advertisers, publishers, printers etc are seen as suppliers.

Future Applications

The inventions described in this product are currently being used to create a published calendar that includes a full daily listing of the user's social network friends' birthdays as well as photographs with friends and targeted advertisements and editorials. The ad revenue allows the product to be printed and delivered to users for free or discounted. Products that are not delivered for free can be downloaded by the user, or alternatively be purchased. There are many more possibilities that can easily be exploited with these inventions, and the company intends to do so by releasing new products on a regular basis. Some of these ideas include:
Diaries/daily planners (published and delivered, enhanced with a personalized address book, friend birthdays and event information and funded through targeted advertising and tips games photos from the users favourite source (magazine, blog, photo-site);
Maps (incorporating personal information such as the location of friends and creating another ad display format for local businesses, trip planner etc.)
Magazines (by partnering with publishing houses, it would be possible to maintain the editorial content of popular magazines but change the advertisements to be individually targeted and/or incorporating user photos/data—and then deliver the published product to the user).

The definition of print and printing extends to include publishing of the product on an offline medium. This extends beyond the narrow definition of “printing” as simply splashing ink onto paper. A relevant example are products that are published to e-paper (popular in Japan and emergent over the next decade as well as non-ink forms of printing to certain types of specialist paper. Downloads to digital readers (typically ebook readers) can be a method of delivery such a the reader product.

Any users can buy the product, but that some users can get discount (even get a product for free) if there are enough advertisements to subsidize the product. Users can also subscribe to a product e.g. planner products where they receive their planner like a magazine with the most up to date content available. At the end of the day success would be determined by the amount of publications in circulation, thus ideally users should receive products on a cyclical continuous bases.

1. A method of producing a printed product, which includes the steps
(a) of retrieving user data from an online social network platform and/or client database and/or user database;
(b) of compiling a printed product incorporating and/or based on the user data and/or preferences, interests, shared interests, online profile, and/or profile of the user and/or the user's friends and/or editorial content from publishers which are matched to users based on the user and/or the user's friends preferences and/or profiles; and
(c) of printing and/or producing/manufacturing the printed product.

2. A method as claimed in claim 1, which includes the step of delivering the product to the user and/or to a location where the user can collect the product.

3. A method as claimed in claim 1 or claim 2, in which print and/or printing includes publishing of the product on an offline medium.

4. A method as claimed in any one of the preceding claims, which includes the step of incorporating the user data into a template of the printed product.

5. A method as claimed in any one of the preceding claims, in which the printed product includes advertisements and/or useful user information.

6. A method as claimed in any one of the preceding claims, which provides for the placement of advertisements in the online domain, but which are then published in the offline domain.

7. A method as claimed in any one of the preceding claims, which is adapted to be used for targeted advertising.

8. A method as claimed in any one of the preceding claims, which incorporates intelligent dynamic pay-per-placement billing.

9. A method as claimed in any one of the preceding claims, which incorporates Internet-driven business model innovations in an offline medium.

10. A method as claimed in any one of the preceding claims, which includes software applications for online social networking platforms to extract data from user profiles.

11. A method as claimed in any one of the preceding claims, in which the user data includes user profiles and/or direct data inputs from user or info filled into a form and/or from secondary sources matched to a user.

12. A method as claimed in any one of the preceding claims, in which demographically targeted advertisements are placed onto the products.

13. A method as claimed in any one of the preceding claims, in which advertisements are delivered via an associated online advertising platform website for marketers.

14. A method as claimed in any one of the preceding claims, which operates in the web software, advanced marketing and/or published media spaces and/or print advertising.

15. A method as claimed in any one of the preceding claims, in which the social network platforms includes any intelligent electronic platform with which users can interact and share information with each other.

16. A method as claimed in any one of the preceding claims, which operates on various social networks and/or data stores simultaneously, enabling one advertiser access to users of multiple social networks.

17. A method as claimed in any one of the preceding claims, in which a cost is estimated of how much advertisers need to pay for advertising based on the profile of customers and the demand for and availability of desired space in the product and/or bidding for user specifics/demographics.

18. A method as claimed in any one of the preceding claims, in which the profile of the customer is determined by the information the user publishes about himself or herself and/or data that is received from him or her completing a form and/or user profiles, questionnaires, forms filled in by users in order to personalize the product.

19. A method as claimed in claim 18, in which the form exists in an application on the social network or website, and may verify the published data as well as request critical data that is not present on the profile and/or be matched to secondary sources to include more useful info into the product.

20. A method as claimed in any one of the preceding claims, in which the profile includes demographic and keyword data such as age, gender and interests and physical location (or past locations visited) and/or previous social network and system platform/interactions by user.

21. A method as claimed in any one of the preceding claims, in which advertisers sign up online and bid accordingly towards enabling their campaign.

22. A method as claimed in any one of the preceding claims, which includes a payment system.

23. A method as claimed in any one of the preceding claims, in which the payment system includes a bidding system and/or a flat calculated rate.

24. A method as claimed in any one of the preceding claims, in which the billing system is dynamic and/or costs fluctuate depending on the number of adverts published and the level of user targeting.

25. A method as claimed in any one of the preceding claims, in which an advertiser specifies preferences about the consumers they are interested in.

26. A method as claimed in any one of the preceding claims, in which the most basic preferences are gender, age and/or location on every or any social network.

27. A method as claimed in any one of the preceding claims, in which the information is published by the user of a social network and/or is entered into direct data input and/or be published by the friend of a user.

28. A method as claimed in any one of the preceding claims, in which age is determined by the users birthday.

29. A method as claimed in any one of the preceding claims, in which gender relies on the user's supplied profile information.

30. A method as claimed in any one of the preceding claims, in which geographic location is determined by the delivery address of the product and/or geographic network specified by the user.

31. A method as claimed in any one of the preceding claims, in which keyword searches provides advertisers the advantage of narrowing down the group to whom they would like to advertise.

32. A method as claimed in any one of the preceding claims, in which data value is added manually by the user and/or automatically be generated by the system to the product by intelligently including useful user information for the user onto the product as well as advertisements and/or editorial content and/or articles and/or other content the user might find interesting and/or of value.

33. A method as claimed in any one of the preceding claims, which includes critical data value components for the consumer which is the “useful information”, namely information existing on the social networking platform that does not yet exist in any offline media such as friend birthdays, events, photos with best friends and/or information from other data sources.

34. A method as claimed in any one of the preceding claims, which combines useful user data and advertisements onto a predetermined product layout along with an attractive graphically designed skin that the user selects and/or self-designs.

35. A method as claimed in any one of the preceding claims, in which the published print product includes at least one of the products selected from the group consisting of a printed calendar, a diary, map, magazine or any other product with a printable surface.

36. A method as claimed in any one of the preceding claims, in which the product is printed and delivered to the customers delivery address and/or to an address/collection point specified by the user.

37. A method as claimed in any one of the preceding claims, in which the user downloads the product and print it independently.

38. A method as claimed in any one of the preceding claims, which utilizes the implementation of a developer Application Programming Interface (API).

39. A method as claimed in any one of the preceding claims, which includes an advertising platform implemented as an online website or web software application that supports advertiser campaigns, intelligent billing and criteria selection and/or articles.

40. A method as claimed in claim 39, in which the advertising platform supports the provision of both picture and text adverts, which may be included on the offline, published product and/or which are placed based on user info, editorials placed and/or the kind of product selected.

41. A method as claimed in any one of the preceding claims, in which advertisements are placed in the Online domain but published in the Offline domain.

42. A method as claimed in any one of the preceding claims, in which basic company server computers and/or virtual software server systems are physically installed at the printing houses where publishing occurs.

43. A method as claimed in any one of the preceding claims, in which the printing house server carries all of the non-variable data (e.g. calendar skins) and software necessary to compile a product, while the variable data (e.g. social user information, ads) is sent to it over the Internet.

44. A method as claimed in any one of the preceding claims, in which delivery of the printed media is accomplished by using registered mail and/or other direct parcel delivery service and/or the user can pick up the products from a central location.

45. A method as claimed in any one of the preceding claims, which includes standardized product templates that are suitable for print.

46. A method as claimed in any one of the preceding claims, which includes the following steps to compile the product:
(a) selection or loading of the correct standardized product template;
(b) adding of the correct design skin to the template;
(c) placing the relevant social network platform data and/or editorial content and/or other content and/or user information from secondary sources and/or forms filled in onto the template;
(d) placing the relevant advertisements and/or relevant editorial content and/or articles onto the template; and
(e) binding and saving the final digital file in a high quality, easily printable format.

47. A method as claimed in any one of the preceding claims, in which the price of an advertisement increases proportionally according to the number of criteria that an advertiser selects as well as those that the system is able to successfully match against an individual user, in addition to other factors and/or quality and completeness of the users profile.

48. A method as claimed in any one of the preceding claims, in which advertisers are billed dynamically as their ads are placed on individual products.

49. A method as claimed in any one of the preceding claims, in which advertisement pricing is influenced by:
(a) Selected criteria (e.g. age, gender, interest keyword, location)
(b) Advertisement size (e.g. A4, A5, business card)
(c) Demand (a bidding feature is likely to be implemented and/or bidding for user profiles, certain publications, or editorial content that is placed next to the ad in the same product)
(d) Campaign limits (e.g. time frames, maximum budget)
(e) Paper and printing quality
(f) Amount of variable data in advertisement (e.g. John buy this iPhone for Sue, it is almost her Birthday)
(g) Page layout (e.g. backpage, next to user picture).

50. A method as claimed in any one of the preceding claims, in which a zip/postal code information is used to add specific area selection options to the advertising platform, allowing advertisers to reach an extremely high level of targeting.

51. A method as claimed in any one of the preceding claims, which is used for the following products in addition to calendars:
(a) Diaries/daily planners (published and delivered, enhanced with a personalized address book, friend birthdays and event information and funded through targeted advertising and/or 3rd party content);
(b) Maps (incorporating personal information such as the location of friends and creating another ad display format for local businesses and/or trip planner);
(c) Magazines (by partnering with publishing houses, it would be possible to maintain the editorial content of popular magazines but change the advertisements to be individually targeted—and then deliver the published product to the user incorporating user photos); and/or
(d) A custom publication created by the user including at least one from (a) to (c) above and from any available content.

52. A method as claimed in any one of the preceding claims, in which users integrate other content with their social network information and/or other content is integrated with a user's social network information.

53. A method as claimed in any one of the preceding claims, in which 3rd party content including advertisements, editorials, blogs is placed based on user profile and/or selection by user.

54. A printed product obtained by means of any one of claims 1 to 53.

55. A printed product, which includes a printed product which incorporates and/or based on user data from an online social network platform and/or multiple platforms if a user has more than one profile.

56. A method of advertising, which includes the steps
(a) of retrieving user data from an online social network platform and/or client database and/or user database and/or direct data input from a user;
(b) of compiling a printed product incorporating advertisements based on the user data and/or preferences, interests, shared interests, online profile, and/or profile of the user and/or the user's friends and/or editorial content from publishers which are matched to users based on the user and/or the user's friends preferences and/or profiles; and
(c) of printing and/or producing/manufacturing the printed product.

57. A method of producing a printed product substantially as described herein with reference to the accompany drawings.

58. A printed product substantially as described herein with reference to the accompany drawings.

59. A method of advertising substantially as described herein with reference to the accompany drawings.
